(19) United States
(12) Patent Application Publication
(10) Pub. No.: US 2010/0174594 A1
(43) Pub. Date: Jul. 8, 2010

(54) My Faves section for a website

(75) Inventors: Connie Jordan, Laguna Niguel, CA (US); Chris Carmichael, Laguna Niguel, CA (US)

Correspondence Address: Law Office of Scott C Harris Inc, PO Box 1389, Rancho Santa Fe, CA, 92067, US

(73) Assignee: UBIQUITY HOLDINGS, San Juan Capistrano, CA (US)

(21) Appl. No.: 12/652,585

(22) Filed: Jan. 5, 2010

Related U.S. Application Data
(60) Provisional application No. 61/142,607, filed on Jan. 5, 2009.

(51) Int. Cl. G06Q 30/00; G06Q 99/00; G06Q 50/00

(52) U.S. Cl. 705/14.16; 705/14.55

(57) ABSTRACT

Social networking site where the user selects advertising material that is shown on their personal section. The user enters favorites, and stored promotional information associated with those favorites is shown to the user. The user selects which of the stored promotional material will be shown on their personal part of their site. The material can be logos or videos, for example.

This application claims priority from Provisional Application 61/142,607, filed Jan. 5, 2009, the entire disclosure of which is herewith incorporated by reference.

### BACKGROUND

Social networking sites, such as facebook, and myspace, are known. These sites have tools which allow users to communicate and interact in various ways with one another.

### SUMMARY

The present application describes a selectable advertisement for a website, e.g., a social networking website.

### BRIEF DESCRIPTION OF THE DRAWINGS

In the Drawings:

FIG. 1 shows a block diagram of an embodiment;

FIG. 2 shows a shot of the different portions; and

FIG. 3 shows a flowchart of operations, e.g, carried out by one or more of the computers.

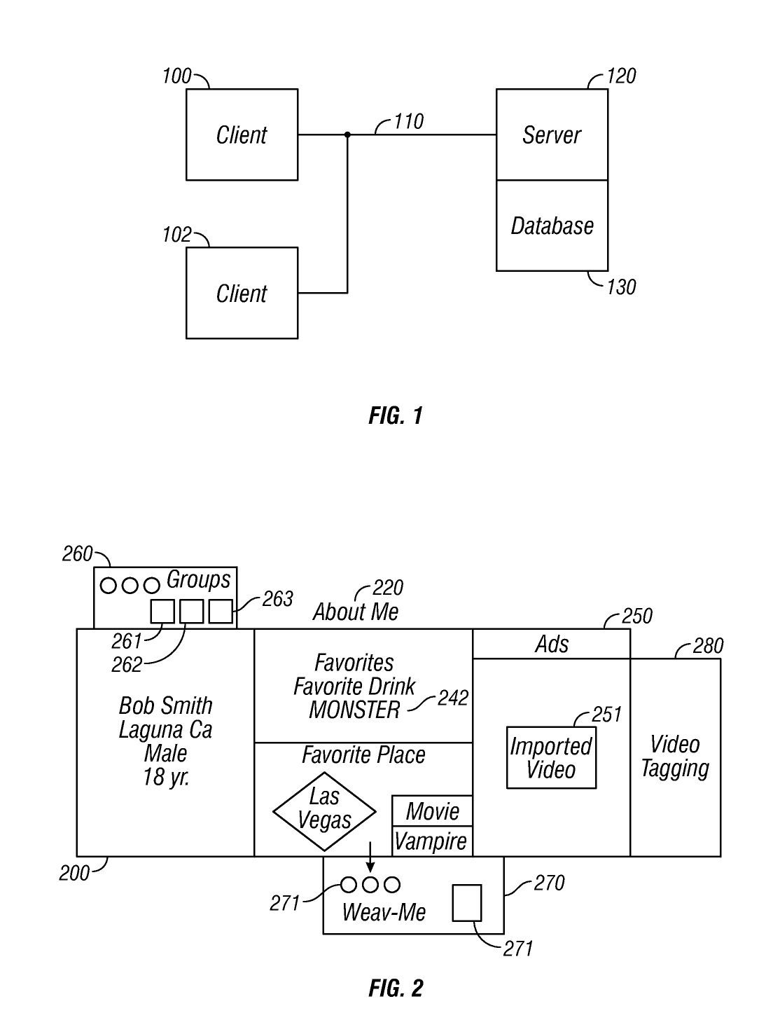

### DETAILED DESCRIPTION

The present application describes a website that can be used to carry out communications between users. One embodiment is a social networking website. However, it should be understood that any network-accessible database for stored information can be used along with the techniques disclosed herein.

According to an embodiment, one of a plurality of different clients such as 100 or 102 connect via the Internet 110 to a server 120 that hosts the website. The server may host the website in any known way, such as by serving HTML using cascading style sheets. Any of a number of clients can store profiles on the server, which are generally stored in the database 130. The server 130, for example, may provide an individualized page for each user. Information from that individualized page can be seen by the user who is associated with the individualized page. Some or all of that information can alternatively be seen by some other user who wants to see information about the user associated with the main page, e.g, friends or would-be friends of the user.

The page may be for example as shown in FIG. 2. The user name 200 is shown along with their fixed information, such as where they live, their sex, and their age. Other fixed information can also be provided. In addition, this can include an “about me” section, which includes information about the user's likes and dislikes. The ads section 215 may provide advertisements which support the operation of the site.

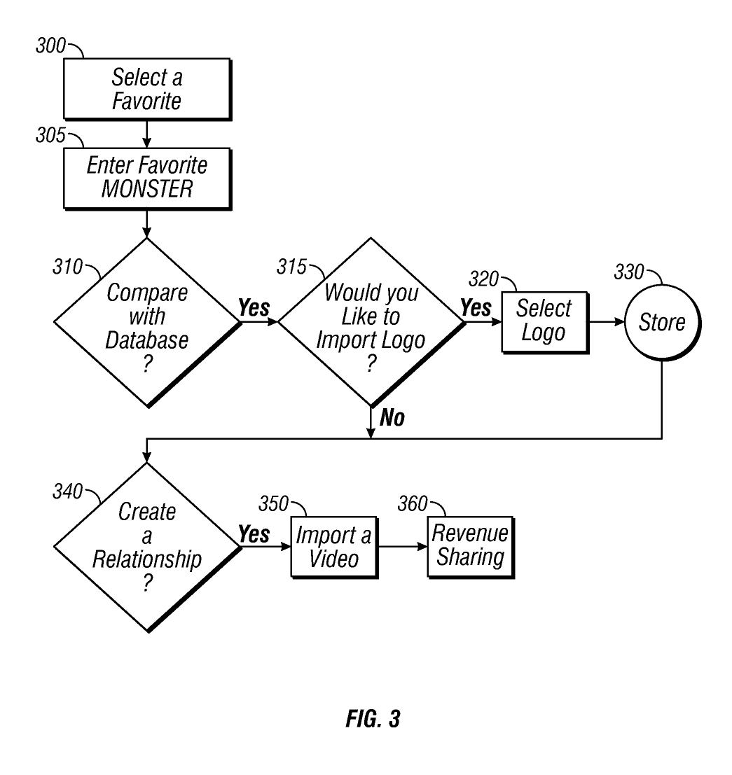

According to an embodiment, the about me section 220 can be used to form a special kind of favorites section that stores preference information for the user. The server 120 may execute a computer program that carries out, for example, the flowchart of FIG. 3. At 300, the user selects a favorite. The favorite is entered at 305, which may be entering via typing, or by selecting from a list. As one example, the favorite category can be selected, here a favorite drink. The user can select, or type in, their favorite drink into the blank. Here the user is shown entering the favorite “monster”.

At 310, the system compares the entry with the database of advertisers, to determine if the entered favorite is within that database. If so, then the user is queried at 315 about whether they would like to import a logo. For example, a user who has entered the word “monster”, would be allowed to import one of the different logos associated with the “monster” brand.

The user can then select a logo at 320 from a group of different prestored logos. The logo selected at 320 is imported into the user's favorites and becomes part of the user's individual page. For example, the monster logo selected at 320 is shown in FIG. 2 as the favorite drink and the logo is shown on the user's individual page at 242. In one embodiment, the logo replaces text information about the user's favorite drink. The viewers then see the logo in place of the text information.

In this way, the user actually selects the advertiser's logo and inserting it into a section about the favorite drinks. This provides special control where the user can select which of their favorites they see ads for, and they can select which of the promotional material for that favorite that they prefer.

While the above has given the example of monster on a drink, it should be understood that other drinks, e.g, Starbucks could also be selected. The information is stored at 320, providing not only information about the user (from their profile at 200) but also which logo the user preferred.

This provides the company with data mining opportunities, and also allows the user to directly request their own advertisement. This provides a special kind of advertisement, since the advertisers have an actual relationship with the user that was selected by the user. The user then shows that logo, here 242, on their own individual page or profile that is shown to their peers. This provides a synergistic ability: it allows the user to interface with the advertisers to gain legal access to their logos, to select which one they like, and at the same time, to show that logo to another person. Rather than the resentment at banners and other types of advertisements that are otherwise placed into a user's profile which they are forced to view, this form of advertising is selected by the user. The inventors believe that the user would be much less resentful towards this kind of advertisement.

305 was described above as selecting a favorite drink. More generally, however, there may be other favorite categories besides drinks. 305 shows selecting the favorite categories, generally as “X”. Other favorites may include favorite places, favorite movies, sports, drinks, TV shows, or anything else where a user might find a favorite.

As one prerequisite to using the site, users may be forced to answer a series of questions about their favorite items. Alternatively, this may be provided as an option that the user can select. Any of those favorite items may also include the ability to create a “relationship” between the user and one or more particular advertisers, where the relationship allows customization of the advertisement associated with the advertisers.

For an advertiser in the database, whether or not the user has selected a logo, the user may then be questioned at 340 about whether they would like to create a relationship as explained herein. In an embodiment, the creation of a relationship provides special benefits to the user. One embodiment includes monetary benefits from the relationship.

Another part of the relationship may be a video ad. If the user answers positively to creating a relationship, they are asked to import a video clip onto their personal site at 350. This video clip is shown on their profile pages, as one of the ads in 250. For example, the imported video 251 may be one of the ads that is shown to anyone who views the profile 200. The video clip may be one of a number of different video advertisements or promotional clips that is associated with the particular advertiser or a partner of the particular advertiser. This provides the user with the ability to select which advertisement they prefer. In this way, users can select the advertisements they view and show. It is believed that allowing the user to select an advertisement will reduce the bad feelings toward an advertisement since, the advertisement is one they selected.

Another embodiment may allow the user to select categories of advertisements, which can change periodically. This can avoid the need to see the same ad over and over.

According to one embodiment, users may be limited in the number of different relationships they can create in this way.

As an example, a user can desire to create a relationship with BMW. The user selects BMW, and asks to download one of their commercials to their profile. That commercial becomes one of the imported videos 251.

The user can also join a user group, or carry out some such operation.

According to another embodiment, the users can participate in advertising revenue via the item(s) they have selected and are showing to others. 360 shows a box called revenue-sharing. According to this paradigm, when other view the user's commercial(s), the user themselves receives a percentage of the revenue obtained by showing that ad. For example, the user may receive some fixed amount of money e,.g., ⅛ cent, each time a friend views their favorite commercial.

The main page can also include a lookup location that indicates to the users how much money they have made through others' viewing their commercials. This encourages the users to be more excited about their commercials rather than treating the commercials is nothing but a burden. This also encourages them to tell their friends to view the commercials on the profile pages.

Another embodiment allows the users to customize the ads, e.g., by editing the commercial to insert other videos in the commercial. The users can also choose to take their income in either CyberCash or in real money, but the system may limit the amount of real money that is produced. Another embodiment may provide a group formation tool, shown as 260 in FIG. 2. This group formation tool allows the users to set different people, as parts of different groups. The groups can include family friends, and public lists. Users can select any of their friends and send it to anyone in their group.

As one example, you could create an album, and want to send it to both friends and family. By clicking the friends button 261 and the family button 262, this can be sent to both friends and family. This system can also be used to allow other users to subscribe to the information that your post.

The subscribers can be separately sent, for example by button 263 where the subscribers are different than friends or family.

When a user creates content such as an album or video, they broadcast that album or video to all of the people on their broadcast lists. In the same manner as above, the broadcasts can be infused with selected commercials from the advertising.

Based on the user's likes and dislikes, another module, referred to herein Weav-me may find other users who have similar likes and dislikes. The Weav-me module 270 may show thumbnail versions of these other users, illustrating individuals with similar interests that are shown in thumbnail form. The user can select any of these thumbnails as an indication of the person they are interested in possibly meeting, and may read their profile. In addition, the Weav me module can set parameters at 271, to include or exclude specific friends.

A video tagging module can be used on the ads, or other videos that are associated with the user's personal area. Video tagging at 280 finds people who appear in videos, e.g., this is Bob Smith. For example, any place in the video can be tagged as including the user, as including specific items such as drinks or the like, or so you can find people who appear in the videos, products that appear in the videos, places where they are shot and the like. By tagging these elements, the item becomes searchable. A user can search through their own library to find specific information within that library, for example.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of advertising can be used. The advertisement can be a conventional style advertising clip. Alternatively, the information can include a less direct style of advertising, for example it can include for example videos which feature the product being advertised being used in the video. One example, for example might be a skier who does downhill skiing, at the end of which they drink a “monster” drink smiles. This is indirect style of advertising may be used as advertisements according to any of the systems described herein.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The website as described herein can be operated on a server computer, or downloaded to the client computer, or operated via a server farm. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method, comprising:
reading information from a server computer;
said information, when executed, causing information indicative of a website to be sent to at least one remote client, wherein said information indicative of a website includes at least one personal page information for a user, said personal page information including information that is specific to the user including fixed information about the user including the user's name, and also including preference information for the user, where said preference information includes at least one product;
providing information to the user and receiving information indicating at least one of said products within said preferences, said information indicative of a user having selected one of a plurality of different advertisements associated with said product;
associating said one of said advertisements with said user's personal page; and
serving information such that users other than said user see said one advertisement when viewing said personal page.

2. A method as in claim 1, wherein said advertisement is a logo associated with said product, where the user selects one of a plurality of different logos, and the selected logo is shown on said personal page.

3. A method as in claim 2, wherein said logo is shown in place of text associated with said product.

4. A method as in claim 3, wherein said logo is a logo associated with the user's favorite drink.

5. A method as in claim 3, wherein said logo is a logo associated with the user's favorite movie.

6. A method as in claim 1, wherein said advertisements are shown in a section of the website that explains personal information about the user.

7. A method as in claim 1, wherein said advertisements are videos associated with said product, where the user selects one of said different videos, and a selected video is shown on their personal page.

8. A method as in claim 7, wherein said video is an advertisement that advertises the product.

9. A method as in claim 7, wherein said video is a promotional video that shows the product being used by other people.

10. A method as in claim 7, further comprising accepting information indicative of tagging in the video, where the tagging represents different places or people that are shown in the video, and further comprising organizing said information according to results of said tagging.

11. A method as in claim 1, further comprising providing revenue to a user each time the advertisements they select is viewed by another.

12. A method, comprising:
storing personal information on a computer associated with a website, for each of a plurality of users;
showing said personal information to other users on said website for each of the users, obtaining favorites information, said favorites information representing a user's selected favorite items for the user;
comparing said favorite items with a database, and determining if said favorite items have associated advertising information in a database;
if said favorite items have said advertising information in the database, then providing a user with a number of different selections of advertising information from the database associated with the specific items;
receiving a response from the user indicating a selection of advertising information, and based on said response, associating one of said advertising information with the personal information on the website associated with the user; and
wherein said showing said personal information on the website also shows said advertising information as selected.

13. A method as in claim 12, wherein said advertising information is a logo, and the user selects one of a number of different logos for their favorite item to appear as part of their personal information.

14. A method as in claim 13, wherein said the selected logo appears as part of the personal information and replaces textual information indicative of the item as part of the personal information.

15. A method as in claim 12, wherein said advertising information is an advertising video, and the user can select one of a number of different videos that is representative of their favorite item, to appear on their website.

16. A method as in claim 15, wherein said advertising video represents a commercial that shows said item.

17. A method as in claim 15, wherein said advertising video comprises a promotional video which does not directly show or commercialize said item, but features said item at in at least one scene in the video.

18. A method as in claim 12, further comprising providing a running count of a number of times that the advertisement on the has been shown to others, and automatically providing money to the user based on said running count.

19. A server computer running a social networking site where the user selects content that will go on the site associated with the user's individual profile, where the individual profile includes at least one favorite item, and said computer accepts a selection of one of a plurality of logos associated with said favorite item, and produces a display of a selected logo on a section of the page associated with said favorite item in place of text representing said favorite item.
